(19) United States
(12) Patent Application Publication
(10) Pub. No.: US 2008/0301553 A1
(43) Pub. Date: Dec. 4, 2008

(54) Verifying compliance of user interfaces with desired guidelines

(75) Inventors: Abhinaba Basu, Kolkata (IN); Gautam Goenka, Hydrabad (IN)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/800,192

(22) Filed: May 4, 2007

(51) Int. Cl. G06F 3/00; G06F 15/00

(52) U.S. Cl. 715/700

(57) ABSTRACT

Verifying the compliance of user interfaces with desired guidelines. In an embodiment, the desired guidelines are specified as a set of validation rules that are to be checked against image frames having multiple display portions. Each validation rule is specified as being applicable to specific interface characteristics. Thus, each validation rule is checked against display portions having matching interface characteristics.

### BACKGROUND

A user interface generally refers to the manner in which a user interacts with a digital processing system (e.g., computer system, mobile phone) and is typically controlled by the operation of various hardware and software components present in the digital processing system.

The user interface is typically based on various output components (e.g., display unit, printer, etc.) and input components (e.g., keyboard, mouse, tablet, etc.). The output components enable information to be provided to the users of digital processing systems, while the input components enable a user to provide inputs.

Image frames are often generated and provided on various output devices. For example, a processor (e.g., central processing unit or display controller) may generate digital data representing the pixels constituting an image of interest, and generate successive image frames (with each image frame representing the image of interest), which are displayed on a display screen of a display unit.

Image frames thus provided form the basis for various desired user interfaces. In general, some portions of an image frame display corresponding information to users and some portions facilitate users to provide desired inputs using appropriate input components. The portions providing information may be termed as output portions and the portions in which user provide inputs may be termed as input portions. A portion may serve both as input and output portion.

It is generally desirable that the user interfaces thus generated comply with various desired guidelines. A guideline represents a desired operation/behavior of the user interface with respect to a specific aspect. As may be readily appreciated, a designer of a user interface may wish that the user interface be in compliance with various desired guidelines.

### SUMMARY

Implementations described herein ensure that image frames in a user interface comply with various desired guidelines. In an embodiment, an image frame is viewed as containing multiple display portions. Each display portion may operate as an output portion and/or an input portion, as described above.

Each display portion is said to have interface characteristics representing the operation, behavior, and/or display of the corresponding portion. Some of the characteristics specify whether a display portion is to operate as an input portion and/or output portion. Some of the output portions may have characteristics specifying the display of the specific text/graphics/video in the corresponding portions. On the other hand, the characteristics of input portions may specify the manner in which a user may provide inputs (e.g., using hardware such as keyboard, mouse, and/or touch pad, using mechanisms such as scrollbar, etc.).

The interface characteristics are generally controlled by a corresponding element defined by the operating environment (combination of one or more of operating system, application program, hardware, etc.). The specific behavior/operation caused by an element is in turn controlled by properties specified associated with the element. Each property has an associated value indicating aspects such as whether the corresponding operation/behavior is enabled/disabled for the portion and potentially the degree to which the property/behavior is applicable in case of input portions, and the specific text to be displayed, font, color, etc., in case of output portions.

The desired guidelines are specified as a set of validation rules that are to be checked against the displayed user interface, with the validation rules reflecting the desired guidelines. Each validation rule is specified as being applicable to elements having a corresponding property.

Accordingly, each element is checked for compliance with validation rules if the element has a property matching the property specified with the validation rule. The results of such validation are then displayed.

For example, in one embodiment, a validation rule may specify that the spelling of displayed text in a display portion is to be checked for correctness, and another validation rule may specify the checking of whether each displayed portion is accessible using a keyboard. The values of properties of elements corresponding to the displayed portion are examined to check for compliance.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWINGS

The present invention will be described with reference to the accompanying drawings briefly described below.

FIG. 1 is a block diagram illustrating the details of a digital processing system in one embodiment.

FIG. 2 is a flowchart illustrating the manner in which compliance of user interfaces with desired guidelines are verified in an embodiment of the present invention.

FIG. 3 depicts an image frame in a user interface for which compliance to desired guidelines is to be verified in an example scenario.

FIG. 4A depicts an interface from which a user may specify a set of validation rules that are to be checked against a displayed image frame (depicted in FIG. 3) in an embodiment.

FIG. 4B depicts the contents of a file used to customize a set of validation rules in an embodiment.

FIG. 5 depicts the various elements in a displayed image frame and the properties associated with each of the elements in an embodiment.

FIG. 6 depicts an interface for displaying the failure of compliance of a displayed image frame to desired guidelines in an embodiment.

In the drawings, like reference numbers generally indicate identical, functionally similar, and/or structurally similar elements. The drawing in which an element first appears is indicated by the leftmost digit(s) in the corresponding reference number.

### DETAILED DESCRIPTION

Example embodiments of the present invention are described with specificity to meet statutory requirements of various jurisdictions in which the subject application may be filed. However, the description itself is not intended to limit the scope of this patent. Rather, the inventors have contemplated that the claimed subject matter might also be embodied in other ways, to include different acts or elements similar to the ones described in this document, in conjunction with other present or future technologies.

1. Example System

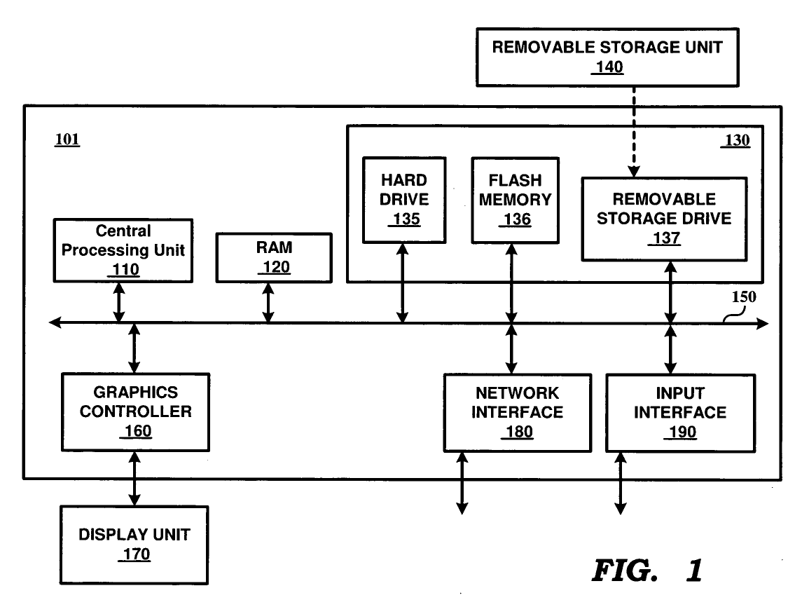

FIG. 1 is a block diagram illustrating the details of a digital processing system facilitating verification of compliance of user interfaces with desired guidelines in one embodiment. Digital processing system 100 is shown containing host 101 connected to display unit 170 and removable storage unit 140. Host 101 is shown containing central processing unit (CPU) 110 (including one or more processors), random access memory (RAM) 120, secondary memory 130, graphics controller 160, network interface 180, and input interface 190. All the components except display unit 170 may communicate with each other over communication path 150, which may contain several buses as is well known in the relevant arts. The components of FIG. 1 are described below in further detail.

CPU 110 may execute instructions stored in RAM 120 to provide several features described herein. CPU 110 may contain multiple processing units, with each processing unit potentially being designed for a specific task. Alternatively, CPU 110 may contain only a single general purpose-processing unit. RAM 120 may receive instructions and data from secondary memory 130 using communication path 150.

Graphics controller 160 generates display signals (e.g., in RGB format) to display unit 170 based on data/instructions received from CPU 110. Display unit 170 contains a display screen to display the images defined by the display signals. The displayed images form the basis for various user interfaces described in the present application. Input interface 190 may correspond to implements such as a keyboards and pointing devices (e.g., a tablet and/or a mouse), which facilitate providing various inputs in conjunction with the displayed images. Network interface 180 provides connectivity to a network (e.g., using Internet Protocol), and may be used to communicate with other systems (not shown in FIG. 1).

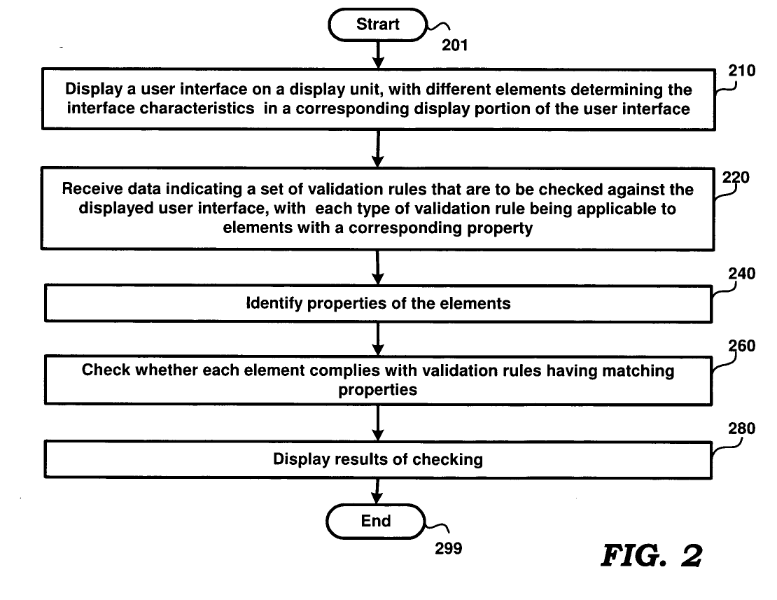

Secondary memory 130 may contain hard drive 135; flash memory 136 and removable storage drive 137. Secondary memory 130 may store various data (e.g., to store the set of validation rules described below) and software instructions (e.g., to provide the features described below with respect to FIG. 2 below). Groups of software instructions (for example, in compiled/object form or post-linking in a form suitable for execution by CPU 110) are termed as code,

Some or all of the data and instructions/code may be provided on removable storage unit 140, and the data and instructions may be read and provided by removable storage drive 137 to CPU 110. Floppy drive, magnetic tape drive, CD-ROM drive, DVD Drive, Flash memory, removable memory chip (PCMCIA Card, EPROM) are examples of such removable storage drive 137.

Removable storage unit 140 may be implemented using mediums and storage formats compatible with removable storage drive 137 such that removable storage drive 137 can read the data and instructions. Thus, removable storage unit 140 includes a computer readable storage medium having stored therein computer software and/or data.

In general, the computer readable medium refers to any medium from which processors can read and execute instructions. The medium can be randomly accessed (such as RAM 120 or flash memory 136), volatile, non-volatile, removable or non-removable, etc. While the computer readable medium is shown being provided from within the digital processing system of FIG. 1 for illustration, it should be appreciated that the computer readable medium can be provided external to the digital processing system as well.

In this document, the term “computer program product” is used to generally refer to such computer readable medium. These computer program products are mechanisms for providing software to host 101. CPU 110 may retrieve the software instructions, and execute the instructions to provide various features of the present invention described below.

It may be appreciated that though the embodiment shows various features operative by execution of corresponding software instructions, alternative embodiments as a combination of one or more of hardware, software and, firmware may be implemented as will be apparent to one skilled in the relevant arts by reading the disclosure provided herein.

Furthermore, though the features are described above with respect to a stand-alone computer system merely for illustration, it should be understood that the various features could be implemented on a combination of systems communicating via a network or other communication paths.

2. Verifying Compliance of User Interfaces With Desired Guidelines

FIG. 2 is a flowchart illustrating the manner in which compliance of user interfaces with desired guidelines are verified in an embodiment of the present invention. The flowchart is described with respect to FIG. 1 merely for illustration. However, various features can be implemented in other environments also without departing from the scope and spirit of several claims presented below, as will be apparent to one skilled in the relevant arts by reading the disclosure provided herein. The flow chart begins in step 201, in which control immediately passes to step 210.

In step 210, host 101 displays an image frame on display unit 170 to provide a user interface, with different elements determining the interface characteristics in a corresponding display portion of the user interface. Elements refer to those definitions in the operating environment that control the interface characteristics of corresponding portions (or portions to which the definitions are directed). Each element is typically embodied by data (or any other pre-specified convention/logic) in the underlying operating environment (e.g., combination of one or more of operating system, application, and hardware platform). Examples of the element types include buttons, menu items, windows, etc., as illustrated in the below sections. It should be appreciated that interface characteristics of a display portion may be determined by multiple elements.

In step 220, host 101 receives data indicating a set of validation rules that are to be checked against the displayed user interface, with each type of validation rule being applicable to elements with matching properties. Thus, in general, each validation rule is specified to apply to elements having matching properties. The properties in the validation rules can be specified using any convention (e.g., complex regular expression), even though simple lists with one or more elements are shown in the examples described below. The data may be, for example, specified in a file in secondary memory 130, received interactively from a user using input interface 190, or received via network interface 180 from external systems.

In step 240, host 101 identifies properties of the elements. In general, certain properties are applicable to certain element types, and the specific properties (including any applicable values) are determined. The identification generally depends on the operating environment. To the extent the operating environment provides programming interface using which the properties can be queried using a suitable convention, the programming interface may be taken advantage of to ascertain the properties. Various approaches may be employed in the operating environment to expose the properties. Some of such approaches include exposing the information related to the properties in a DOM (document object model) and injecting specific software instructions into the application forming the display screen, with the instructions facilitating receipt of properties of the elements (for example, by appropriate queries according to a pre-specified convention using techniques such as inter-process communication).

In step 260, host 101 checks whether each element complies with validation rules having matching properties. That is, if a validation rule is applicable to a property, then the elements having that property are checked for compliance with the validation rule. The checking generally depends on the validation to be performed and depends on the specific properties, as described with examples in sections below.

In step 280, host 101 displays results of checking on display unit 170. Alternatively, the results may be stored in secondary memory 130 or transmitted on network interface 180. The user may then perform an appropriate action (e.g., correcting the software instructions) as suited for the specific situation. The flow chart ends in step 299.

While the flowchart is described with respect to checking compliance of a user interface after display on a display unit, it should be appreciated such checking can be performed without display of the images as well. For example, once the image (corresponding to the displayed user interface) is generated (by CPU 110 or graphic controller 160), the images can be checked for compliance with desired guidelines.

In addition, the generation of the image can be performed in one system and steps 220, 240 and 260 described above can be performed in another system, potentially connected by a network or point-to-point line. Thus, one system may generate pixels representing an image frame and another system (after receiving on a communication path) may check for the compliance of the image frame with the applicable guidelines.

Whether the compliance is performed in the same system or a different system, a software/component may first receive data representing an image frame and perform steps 220, 240 and 260 using the received data.

By checking compliance of image frames with desired guidelines, a testing personnel may confirm the accuracy of (or know errors with) specific use cases, which the eventual users are likely to encounter with the software application.

The description is continued with an example illustration of the features described above with respect to FIG. 2.

3. Illustration With an Example

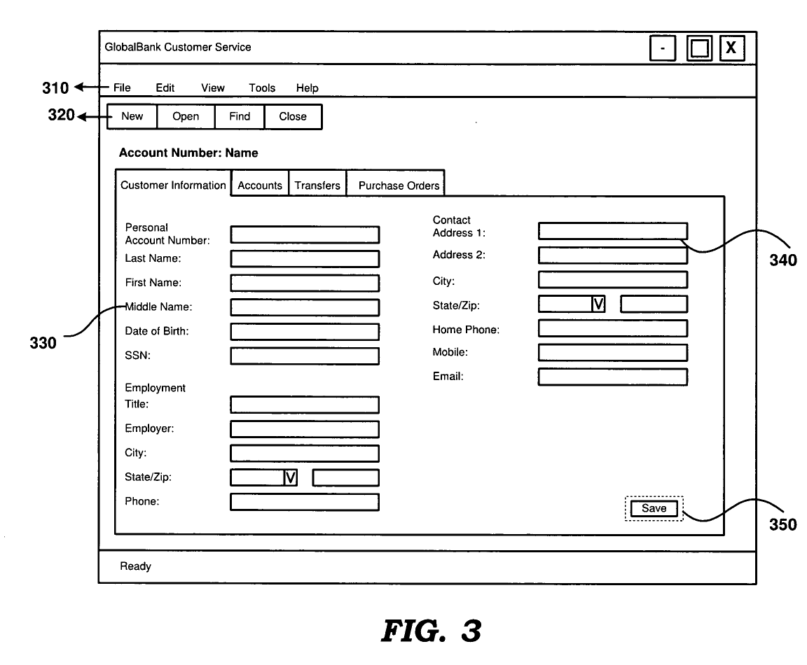

FIGS. 3, 4A, 4B, 5 and 6 together illustrate the manner in which compliance of user interfaces with desired guidelines is verified in an example embodiment. The embodiment is implemented in Windows XP environment provided by Microsoft Corporation. However, the features can be implemented in various other embodiments/environments (e.g., using Java™ Accessibility technology from Sun Microsystems), as will be apparent to one skilled in the relevant arts by reading the disclosure provided herein. Each of the Figures is described below in detail.

FIG. 3 depicts an example image frame in a user interface for which compliance with desired guidelines is to be verified in an example scenario. Title 310, menu 320, label 330, field 340 and button 350 are various elements of the user interface. It may be observed that elements such as title 310, label 330 and button 350 have texts “GlobalBank Customer Service”, “Middle Name” and “Save” associated respectively (as would be specified in the properties in the software code/data generating the user interface). Field 340 may also have text (inputted by the user) associated with the element.

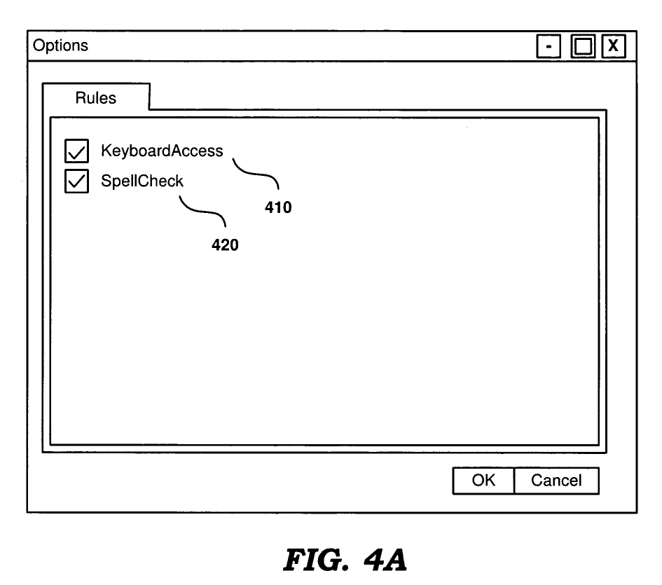

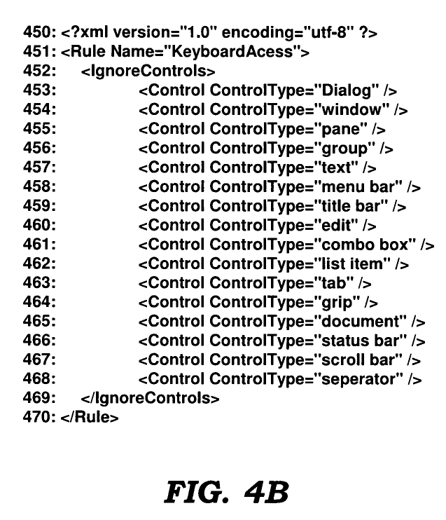

FIG. 4A depicts an interface from which a user may specify a set of validation rules that are to be checked against a displayed user interface (depicted in FIG. 3) in an embodiment. Two example validation rules are shown displayed, and the user merely selects (shown checked off in the corresponding boxes for both rules 410 and 420) the desired ones of the validation rules which facilitate checking of compliance with corresponding guidelines. Though only two example validation rules are shown there for illustration, it should be appreciated that additional validation rules, as suited for specific situations can be employed based on the disclosure provided herein.

Rule 410 “KeyboardAccess” specifies a validation rule, whereby each of the elements in the displayed user interface is verified for accessibility via a keyboard. The value of properties such as “Accelerator” and “AccessKey” (not shown in the drawings) of the elements may be checked to verify whether a keyboard shortcut has been specified for the element.

Rule 420 “SpellCheck” specifies another validation rule, whereby text associated with each of the elements defining the properties of the portion in the displayed screen is verified for spelling. The value of a property such as “Name” of the element may specify the text that is to be checked for spelling. The verification of spelling is typically performed by first splitting the text into words. The words are then checked for occurrence in a pre-defined list of words (called a “dictionary”). It may be appreciated that custom dictionaries containing words specified by a user may be used in addition to any pre-defined list of words.

It may be appreciated that the interface of FIG. 4A may be used to specify the validation rules after displaying the user interface depicted in FIG. 3. Alternatively, a user may specify the validations rules first and then indicate a displayed user interface for verifying compliance.

The validation rules may be applied for all the (matching) elements in the displayed user interface. However, it may be desirable to have a feature by which specified elements may be included or excluded from being checked when a validation rule is applied. Such inclusion/exclusion may be desirable, for example, to apply some of the rules selectively to some instances of the elements, but not others. The description is continued describing the manner in which a validation rule may be customized to specify the exclusions.

FIG. 4B depicts the contents of a file used to customize a set of validation rules in an embodiment. The contents of the file are specified in extensible markup language (XML) format (as specified by line 450 “xml”). Lines 451-470 (between tags “<Rule>” and “</Rule>”) depicts the customization applied to a validation rule with name “keyboardAccess” that is rule 410.

Lines 452-469 (between tags “<IgnoreControls>” and “</IgnoreControls>”) specify the various elements (or controls) that are to be excluded (or ignored) during the application of rule 410 to the displayed user interface. Line 453 (tag “<Control>”) depicts a control with control type “Dialog” that is to be ignored during the application of rule 410. Similarly lines 454 to 468 depict various controls (as specified by the controltype property) that are to be ignored during the application of rule 410.

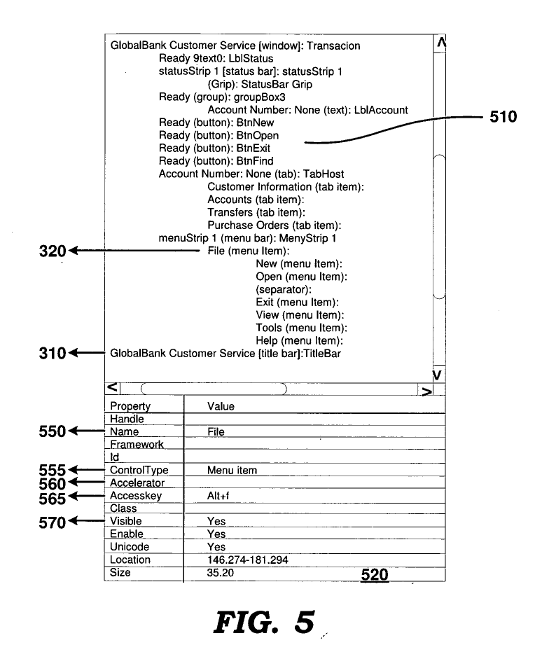

FIG. 5 depicts the various elements in a displayed image frame (as depicted in FIG. 3) and the properties associated with each of the elements in an embodiment. It should be appreciated that only example properties are shown and only some of the displayed properties described for illustration. However, the features can be implemented with reference to other properties, potentially in the context of other environments.

Panel 510 depicts all the elements of the displayed user interface in a hierarchical manner. The hierarchy is shown with elements such as title 310 and menu 320 of the displayed user interface depicted in FIG. 3. Panel 520 depicts example properties of an element (menu 320) selected in panel 510. Properties 550 “Name”, 555 “ControlType”, 560 “Accelerator”, 565 “Accesskey” and 570 “Visible” may be used during the checking of compliance of the elements to the validation rules as described in detail below.

In a scenario of checking rule 410 “KeyboardAccess” for each of the elements, property 555 “ControlType” of each of the elements' is first verified as not occurring in the list of controls specified by lines 453 to 468 (which depict the controls to be ignored).

For checking rule 410 for elements that needs to be verified, the values of properties 560 “Accelerator” and 565 “Accesskey” for each of the elements are inspected. If the values of both properties 560 and 565 are absent or empty (“”), the element is determined to not have complied with rule 410 and if one of the values is present, the element is determined to have complied with rule 410. For example, menu 320 has a value of “Alt+f” in the property 565 “Accesskey” and is therefore determined to be compliant with rule 410.

In a scenario of checking rule 420 “SpellCheck”, the value of property 570 “Visible” of each of the elements is first checked and the validation rule 420 is applied only to visible elements, that is, whose value is “Yes”. The text comprised in the value of property 550 “Name” of each of the visible elements is checked for spelling. An element is determined to be compliant with rule 420 if checking of the spelling of the text is successful and not compliant otherwise. For example, menu 320 is determined to be compliant with rule 420 since the text “File” associated with property 550 “Name” of the element is spelled correctly.

It may be appreciated that in the scenario where compliance with desired guidelines (specified by the validation rules) is not observed, the user may be notified of failure of compliance of the displayed user interface. The description is continued with an example interface for notifying the user of failure of compliance of a displayed user interface.

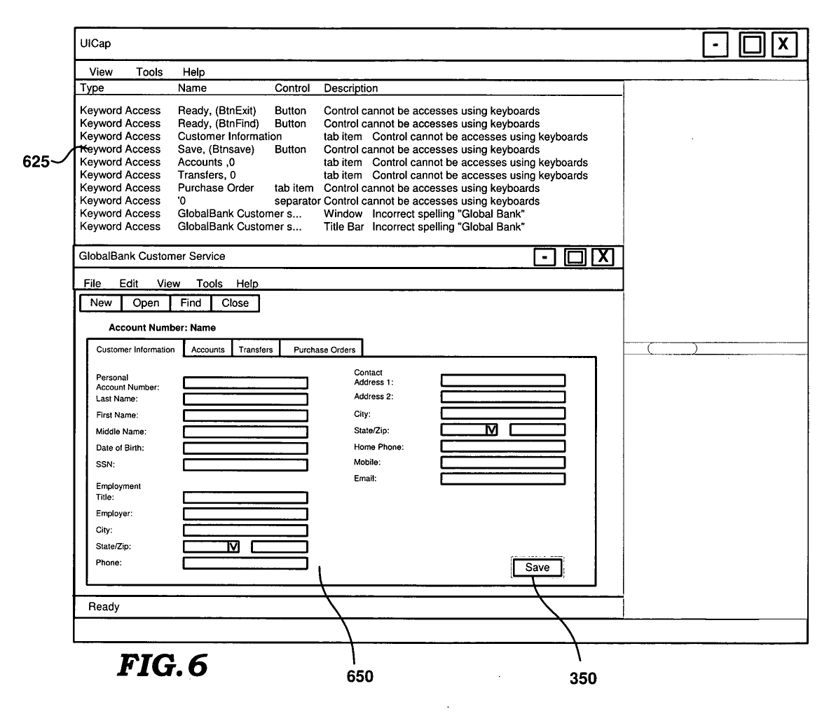

FIG. 6 depicts an interface for displaying the failure of compliance of a displayed image frame (depicted in FIG. 3) to desired guidelines (as specified by the set of validation rules depicted in FIG. 4A and 4b) in an embodiment. Panel 620 depicts the various failures of compliance of the displayed user interface (depicted in panel 650) to the desired guidelines. Error 625 depicts a failure of compliance of element button 350 to rule 410 “KeyboardCheck” and the element is highlighted in panel 650.

4. Conclusion

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer readable medium containing a plurality of instructions which when executed causes one or more processors to process an image frame, said computer readable medium comprising:
code for receiving an image frame that forms part of a user interface, said image frame containing a plurality of display portions, each of said display portions having a corresponding set of interface characteristics;
code for receiving a set of validation rules indicating interface characteristics to be checked against said plurality of display portions; and
code for checking whether each of said plurality of interface characteristics of said plurality of display portions complies with said set of validation rules.

2. The computer readable medium of claim 1, further comprising code for displaying said image frame on a display unit, wherein said checking is performed after said displaying.

3. The computer readable medium of claim 2, wherein one of more of said set of validation rules represents a desired guideline.

4. The computer readable medium of claim 1, wherein each of said interface characteristics is controlled by a corresponding one of a plurality of elements, each of said plurality of elements having an associated set of properties,
wherein each of said set of validation rules is specified as being applicable to elements having a corresponding set of properties,
wherein said code for checking checks whether each of said plurality of elements complies with each of said set of validation rules if the element has said corresponding set of properties.

5. The computer readable medium of claim 4, wherein said code for receiving further receives a plurality of values for a third property for which the corresponding validation rule is not to be checked, wherein said code for checking avoids checking said corresponding validation rule if an element has said third property with one of said plurality of values.

6. A computer readable medium carrying one or more sequences of instructions causing a system to verify compliance of user interfaces with desired guidelines, wherein execution of said one or more sequences of instructions by one or more processors contained in said system causes said system to perform the actions of:
receiving an image frame, said image frame containing a plurality of display portions, each of said display portions having a corresponding set of interface characteristics;
receiving a set of validation rules indicating interface characteristics to be checked against said plurality of display portions, said set of validation rules reflecting said desired guidelines; and
checking whether each of said plurality of interface characteristics complies with said set of validation rules.

7. The computer readable medium of claim 6, further comprising one or more instructions for displaying said image frame on a display unit and then performing said checking.

8. The computer readable medium of claim 6, wherein each of said interface characteristics is controlled by a corresponding one of a plurality of elements, each of said plurality of elements having an associated set of properties,
wherein each of said set of validation rules is specified as being applicable to elements having a corresponding set of properties,
wherein said checking checks whether each of said plurality of elements complies with each of said set of validation rules if the element has said corresponding set of properties.

9. The computer readable medium of claim 8, wherein said data further indicates a plurality of values for a third property for which the corresponding validation rule is not to be checked, wherein said checking avoids checking said corresponding validation rule if an element has said third property with one of said plurality of values.

10. The computer readable medium of claim 6, wherein said set of validation rules comprises a first rule to check a spelling of a text displayed in said image frame.

11. The computer readable medium of claim 6, wherein said set of validation rules comprises a second rule to check whether a first portion comprised in said plurality of portion is accessible via an input device.

12. A method of verifying compliance of user interfaces with desired guidelines, said method comprising:
receiving an image frame to be displayed on a display unit as a part of a user interface, said image frame containing a plurality of display portions and each display portion having corresponding interface characteristics, with said interface characteristics of each display portion being controlled by a corresponding one of a plurality of elements, each of said plurality of elements having an associated set of properties;
receiving a set of validation rules that are to be checked against said user interface, said set of validation rules reflecting said desired guidelines, wherein each of said set of validation rules is specified as being applicable to elements having a corresponding set of properties; and
checking whether each of said plurality of elements complies with each of said set of validation rules if the element has said corresponding set of properties.

13. The method of claim 12, wherein said set of validation rules comprises a first rule to check a spelling of a text displayed in said image frame.

14. The method of claim 13, wherein said checking comprises identifying elements having a first property, wherein said text is specified as a value corresponding to said first property, and comparing with entries in a dictionary to determine if said spelling of said text is incorrect.

15. The method of claim 12, wherein said set of validation rules comprises a second rule to check whether a first portion comprised in said plurality of portion is accessible via an input device.

16. The method of claim 15, wherein said checking comprises examining a second property of said plurality of elements, wherein said second property indicates whether the corresponding portion is accessible by said input device.

17. The method of claim 12, wherein said data further indicates a plurality of values for a third property for which the corresponding validation rule is not to be checked, wherein said checking avoids checking said corresponding validation rule if an element has said third property with one of said plurality of values.

18. The method of claim 12, further comprising displaying said image frame on said display unit, wherein said checking is performed after said displaying.

19. The method of claim 12, further comprising displaying the results of said checking on said display unit.
